(19) United States
(12) Patent Application Publication
(10) Pub. No.: US 2013/0200831 A1
(43) Pub. Date: Aug. 8, 2013

(54) POWER SUPPLY DEVICE

(71) Applicants: Yasushi Nakano, Hitachinaka (JP); Yoshikazu Kawano, Hitachinaka (JP); Nobuhiro Takano, Hitachinaka (JP); Kazuhiko Funabashi, Hitachinaka (JP)

(72) Inventors: Yasushi Nakano, Hitachinaka (JP); Yoshikazu Kawano, Hitachinaka (JP); Nobuhiro Takano, Hitachinaka (JP); Kazuhiko Funabashi, Hitachinaka (JP)

(21) Appl. No.: 13/878,867

(22) PCT Filed: Oct. 24, 2011
(86) PCT No.: PCT/JP2011/005926

§ 371 Date: Apr. 11, 2013

(30) Foreign Application Priority Data
Oct. 27, 2010 (JP) 2010240801

(51) Int. Cl. H02M 7/5387; H02P 27/08

(52) U.S. Cl. CPC H02M 7/5387; H02P 27/08
USPC 318/400.29; 363/37; 327/540

(57) ABSTRACT

A power supply device includes: an inverter that converts a DC power supplied from a battery pack into an AC power and outputs the AC power; and an adapter shapes a waveform of the AC power outputted from the inverter.

### TECHNICAL FIELD

The present invention relates to a power supply device having an inverter, a power tool equipped with the power supply device, and a power supply system equipped with the power supply device and the power tool.

### BACKGROUND ART

A conventional power supply device disclosed in Japanese Patent Application Publication No. 2009-278832 is provided with an inverter for converting DC power supplied from a battery pack into a square-wave AC power and outputting this square-wave AC power to an AC-powered power tool.

### DISCLOSURE OF INVENTION

### Solution To Problem

The above power supply device is not provided with a circuit for shaping the square-wave AC power to a sine-wave AC power to prevent the device from becoming too large. However, it is desired to drive some power tools possessing a motor speed control function for controlling the rotational speed of the motor through phase control and driven with the sine-wave AC power, using the above power supply device.

In view of the foregoing, it is an object of the present invention to provide a power supply device that has an inverter as its main component and that is capable of driving even a power tool possessing a motor speed control function by phase-controlling the rotational speed of the motor in the power tool, while suppressing an increase in the size of the inverter.

In order to attain the above and other objects, the invention provides a power supply device including: an inverter that converts a DC power supplied from a battery pack into an AC power and outputs the AC power; and an adapter that shapes a waveform of the AC power outputted from the inverter.

It is preferable that the power supply device further includes a controller that controls the inverter to change a waveform of the AC power to be outputted in accordance with a connection status of an adapter to the inverter, the adapter shaping the waveform of the AC power outputted from the inverter.

It is preferable that the controller controls the inverter to output a square-wave AC power having a commercial frequency when the adapter is not connected to the inverter, and the controller controls the inverter to output a PWM sine-wave AC power when the adapter is connected to the inverter.

It is preferable that the inverter includes: a first switching element that is turned on/off to convert the DC power supplied from the battery pack into an AC power; a rectifying/smoothing circuit that converts the AC power converted by the first switching element into a DC power; and an inverter circuit including a plurality of second switching elements that is turned on/off to convert the DC power converted by the rectifying/smoothing circuit into an AC power. The controller controls the ON/OFF of the plurality of second switching elements based on the connection status.

It is preferable that the adapter includes a low-pass filter that shapes the PWM sine-wave AC power into a sine-wave AC power.

It is preferable that the adapter includes an identifying member that outputs an identifying signal to the controller when the adapter is connected to the inverter.

It is preferable that the inverter further includes a first resistor having a first terminal connected to a power source and a second terminal connected to the controller, and the identifying member includes a first resistor connected between the second terminal and a ground when the adapter is connected to the inverter.

Another aspect of the present invention provides a power tool connectable to the power supply, including: an AC motor; and a trigger switch disposed between the adapter and the AC motor when the adapter is connected between the inverter and the AC motor and between the inverter and the AC motor when the adapter is not connected between the inverter and the AC motor.

Another aspect of the present invention provides a power supply system including: the power supply device; and the power tool.

Another aspect of the present invention provides an adapter including: a first terminal connectable to an inverter that converts a DC power supplied from a battery pack into an AC power and outputs the AC power; a shaping unit that shapes a waveform of the AC power outputted from the inverter; and a second terminal that outputs the shaped waveform.

### Advantageous Effects of Invention

The present invention is capable of providing a power supply device that has an inverter as its main component and that is capable of driving even a power tool possessing a motor speed control function by phase-controlling the rotational speed of the motor in the power tool, while suppressing an increase in the size of the inverter.

### BRIEF DESCRIPTION OF DRAWINGS

FIG. 1 is a circuit diagram of a power supply device according to the present invention having an adapter connected to an inverter;

FIG. 2 is a circuit diagram of the power supply device having only an inverter;

FIG. 3 is an explanatory diagram illustrating waveforms of signals outputted by the inverter and adapter in the power supply device; and

FIG. 4 is a flowchart illustrating steps in a process for controlling the power supplied to the AC motor in the power supply device.

### REFERENCE SIGNS LIST

1 Power supply device

2 Inverter

3 Adapter

4 Power tool

5 Battery pack

28 Microcomputer

### BEST MODE FOR CARRYING OUT THE INVENTION

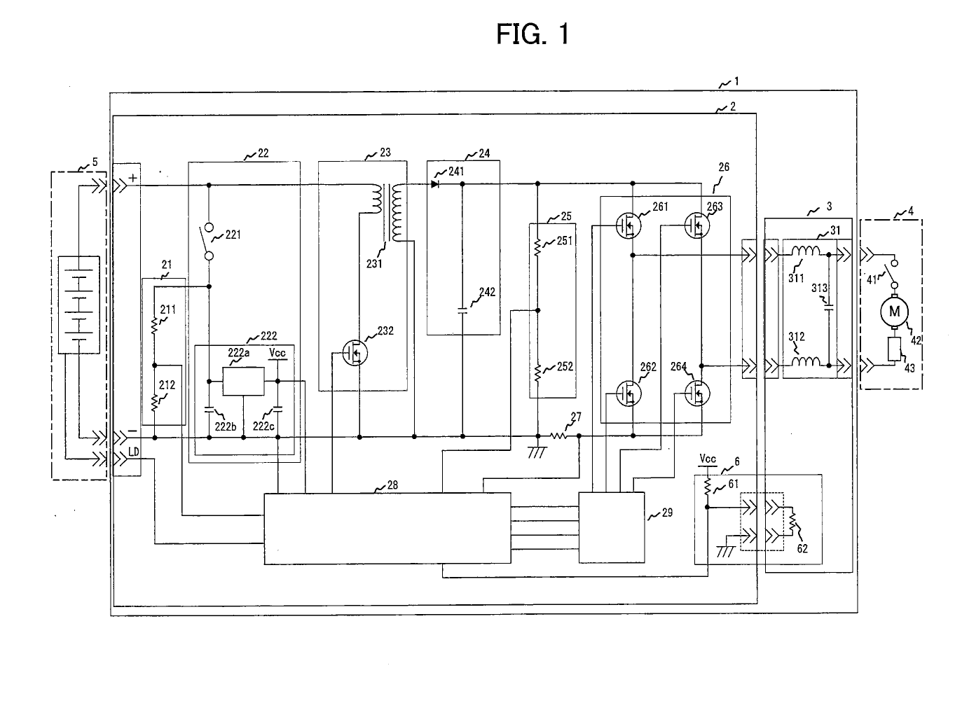

Next, a power supply device according to a preferred embodiment of the present invention will be described while referring to FIGS. 1 through 4.

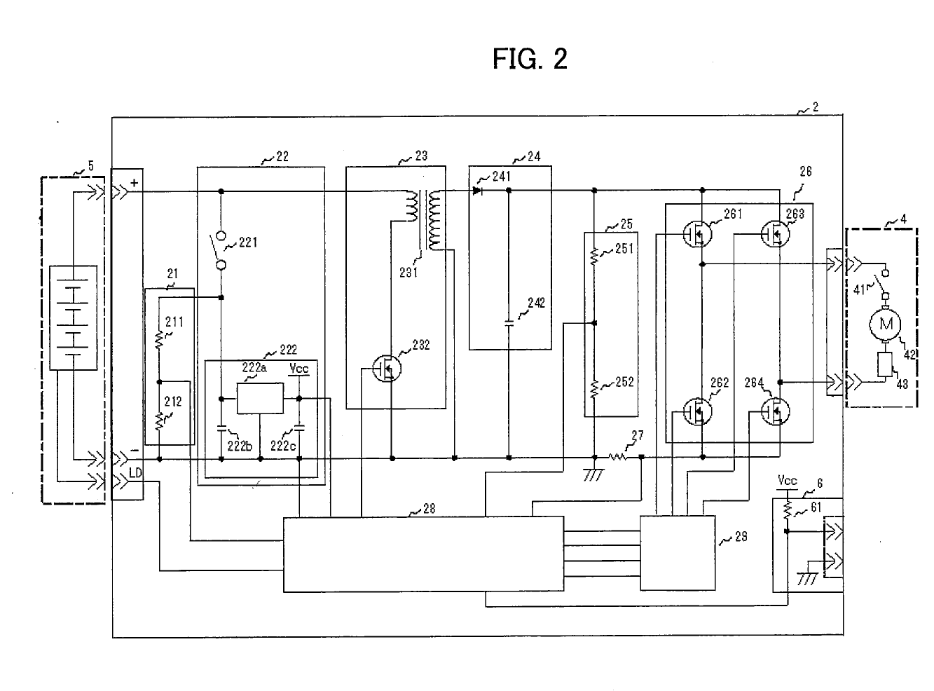

FIG. 1 is a circuit diagram of a power supply device 1 according to a preferred embodiment of the present invention, showing the connected states of an inverter 2, an adapter 3, a power tool 4, and a battery pack 5. FIG. 2 is a circuit diagram of the power supply device 1 in FIG. 1 after removing the adapter 3 and connecting the power tool 4 directly to the inverter 2.

As shown in FIG. 1, the power supply device 1 includes the inverter 2 and the adapter 3. The battery pack 5 is connected to the inverter 2. When an operator operates a power switch 221 (described later) of the inverter 2 (i.e., switches on the power switch 221), the inverter 2 converts DC power supplied from the battery pack 5 to an AC power having a square-waveform (hereinafter referred to as the “square-wave AC power”). The battery pack 5 is a lithium battery pack configured of four 3.6-V lithium battery cells connected in series for a rated voltage of 14.4 V.

When the power tool 4 is a disc grinder, for example, or other device, an AC motor 42 provided in the power tool 4 requires phase control, that is, requires an AC power having a sine-waveform (hereinafter referred to as the “sine-wave AC power”). In such case, by connecting the adapter 3 between the inverter 2 and the power tool 4, the square-wave AC power outputted from the inverter 2 is shaped to the sine-wave AC power, and the sine-wave AC power is outputted to the AC motor 42.

On the other hand, when the power tool 4 is a lawn mower, for example, or other device, the AC motor 42 provided in the power tool 4 does not require phase control. In such case, by not connecting the adapter 3 between the inverter 2 and the power tool 4, the square-wave AC power outputted from the inverter 2 is directly outputted to the AC motor 42. The shaping of the square-wave AC power into the sin-wave AC power will be described later.

The inverter 2, adapter 3, power tool 4, and battery pack 5 are all detachably connected to each other. However, unless the connected states of these members are otherwise specified, the following description assumes that the components are in a connected state.

The inverter 2 includes a battery voltage detection unit 21, a power supply unit 22, a booster circuit unit 23, a rectifying/smoothing circuit 24, a boost voltage detection unit 25, an inverter circuit 26, a current detection resistor 27, a microcomputer 28, and a PWM signal output unit 29.

The adapter 3 includes a low-pass filter 31 configured of choke coils 311 and 312 and a capacitor 313. The low-pass filter 31 shapes a square-wave AC power outputted from the inverter 2 to a sine-wave AC power.

The power tool 4 includes a switch 41, the AC motor 42, and a rotating speed controller 43. When the switch 41 is turned on, the AC motor 42 is driven with the AC power outputted from the inverter 2 or the adapter 3 under the control of the rotating speed controller 43.

Further, the inverter 2 and adapter 3 are co-provided with an adapter identification unit 6. The adapter identification unit 6 enables the microcomputer 28 to identify whether or not the adapter 3 is connected to the inverter 2.

The adapter identification unit 6 is configured of a first resistor 61 provided in the inverter 2 and a second resistor 62 provided in the adapter 3. When the adapter 3 is connected to the inverter 2, as shown in FIG. 1, the adapter identification unit 6 outputs, to the microcomputer 28, a divided voltage of a power supply voltage Vcc (5 V, for example) by the first resistor 61 and the second resistor 62. On the other hand, when the adapter 3 is not connected to the inverter 2, as shown in FIG. 2, the adapter identification unit 6 outputs the power supply voltage Vcc directly to the microcomputer 28 via the first resistor 61. With this configuration, the microcomputer 28 is able to identify whether or not the adapter 3 is connected to the inverter 2.

Next, the circuit structure of the inverter 2 will be described in greater detail with reference to FIG. 1.

The battery voltage detection unit 21 includes resistors 211 and 212 connected in series. The battery voltage detection unit 21 detects the battery voltage received from the battery pack 5 and outputs a divided voltage of the battery voltage by the resistors 211 and 212 to the microcomputer 28.

The power supply unit 22 includes a power switch 221, and a constant-voltage circuit 222 connected in series between the battery pack 5 and microcomputer 28. The constant-voltage circuit 222 includes a three-terminal regulator 222a, and oscillation prevention capacitors 222b and 222c. When an operator turns on the power switch 221, the power supply unit 22 converts the battery voltage into a prescribed DC (drive) voltage Vcc (5 V, for example) and supplies the drive voltage Vcc to the microcomputer 28 and the adapter identification unit 6. When the operator switches off the power switch 221, the entire inverter 2 is switched off because the drive voltage Vcc is no longer supplied to the microcomputer 28.

The booster circuit unit 23 is configured of a transformer 231, and a field effect transistor (FET) 232. The microcomputer 28 described later is connected to the gate of the FET 232 and turns the FET 232 on and off with a first PWM signal. The DC power supplied from the battery pack 5 to the primary winding of the transformer 231 is converted into an AC power in accordance with the on and off of the FET 232. The AC voltage of the AC power is stepped up in the secondary winding of the transformer 231 (boost AC voltage).

The rectifying/smoothing circuit 24 is configured of a diode 241, and a capacitor 242, and converts the boost AC voltage outputted from the transformer 231 to a DC voltage.

The boost voltage detection unit 25 includes resistors 251 and 252 connected in series. The boost voltage detection unit 25 detects the DC voltage outputted from the rectifying/smoothing circuit 24 (the voltage at the capacitor 242) and outputs, to the microcomputer 28, a divided voltage of the DC voltage by the resistors 251 and 252.

The inverter circuit 26 is configured of four FETs 261-264. The gates of the FETs 261-264 are all connected to the PWM signal output unit 29 described later. The PWM signal output unit 29 turns the FETs 261-264 on and off with second PWM signals, thereby converting the DC power outputted from the rectifying/smoothing circuit 24 into an AC power.

The current detection resistor 27 is connected between the source of the FET 262 (FET 264) and the ground. The terminal on the upstream side of the current detection resistor 27 is also connected to the microcomputer 28. With this configuration, the microcomputer 28 can detect the current flowing to the AC motor 42 based on the voltage outputted from the current detection resistor 27.

The microcomputer 28 controls the FET 232 through feedback. Specifically, the microcomputer 28 generates, based on the boost voltage at the capacitor 242 detected by the boost voltage detection unit 25, a first PWM signal for maintain the DC voltage outputted from the rectifying/smoothing circuit 24 at a desired level (140 V, for example), and outputs the first PWM signal to the gate of the FET 232.

The microcomputer 28 also generates second PWM signals for outputting an AC power having a specified power waveform from the inverter circuit 26, and outputs the second PWM signals to the PWM signal output unit 29. The PWM signal output unit 29 transmits the second PWM signals to the gates of the FETs 261-264 in the inverter circuit 26 to turn the FETs 261-264 on and off.

Further, the microcomputer 28 changes the second PWM signals based on the signal outputted from the adapter identification unit 6.

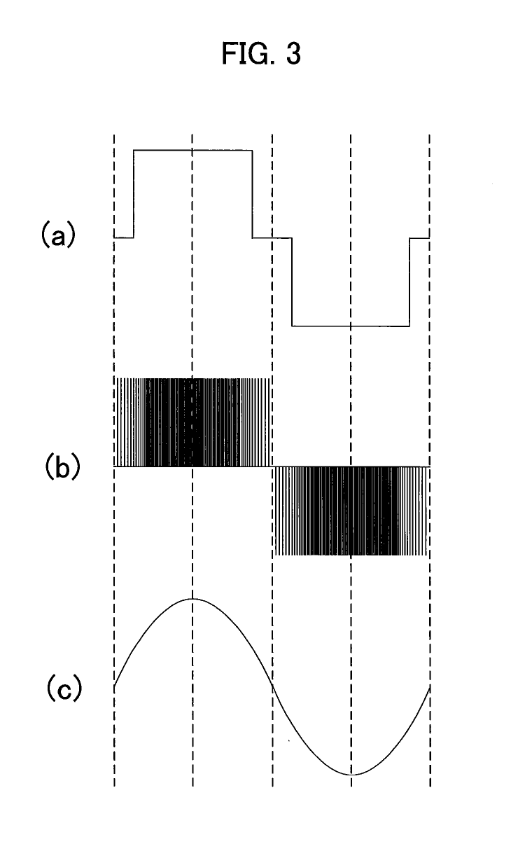

Specifically, when the adapter 3 is not connected to the inverter 2, as shown in FIG. 2, i.e., when the power tool 4 is directly connected to the inverter 2, the microcomputer 28 outputs second PWM signals for outputting a square-wave AC power from the inverter circuit 26, as illustrated in FIG. 3(a). Specifically, the microcomputer 28 outputs second PWM signals for alternately turning on and off a set of the FETs 261 and 264 in the inverter circuit 26 (hereinafter referred to as the “first set”) and a set of the FETs 262 and 263 (hereinafter referred to as the “second set”) at a duty cycle of 100%.

In this case, a square-wave AC power, as shown in FIG. 3(a), is supplied directly to the AC motor 42.

However, when the adapter 3 is connected to the inverter 2, as shown in FIG. 1, i.e., when the power tool 4 is connected to the inverter 2 via the adapter 3, the microcomputer 28 outputs second PWM signals for outputting a PWM sine-wave AC power from the inverter circuit 26 is, as shown in FIG. 3(b). Specifically, the microcomputer 28 outputs second PWM signals for switching the first and second sets in the inverter circuit 26 on and off at a carrier frequency on the order of several tens of kilohertz with variable duty cycle.

In this case, the PWM sine-wave AC power shown in FIG. 3(b) is shaped to a sine-wave AC power, as shown in FIG. 3(c) when passing through the low-pass filter 31 of the adapter 3. Thus, the sine-wave AC power is supplied to the AC motor 42. The sine-wave AC power can ensure reliable operations, even in power tools requiring phase control.

The microcomputer 28 also determines whether or not an over-discharge has occurred in the battery pack 5 based on the battery voltage detected by the battery voltage detection unit 21. More specifically, when the battery voltage detected by the battery voltage detection unit 21 is less than or equal to a prescribed value, the microcomputer 28 determines that an over-discharge has occurred in the battery pack 5 and halts the first and second PWM signals to stop operations of the FET 232 and FETs 261-264. The battery pack 5 is further provided with a built-in protection circuit or microcomputer for self-detecting over-discharge, and possesses a function to output an over-discharge signal to the microcomputer 28 when over-discharge has been detected. Upon receiving this over-discharge signal from the battery pack 5 via the LD terminal, the microcomputer 28 halts the first and second PWM signals. This configuration can prevent such over-discharge from shortening the lifespan of the battery pack 5.

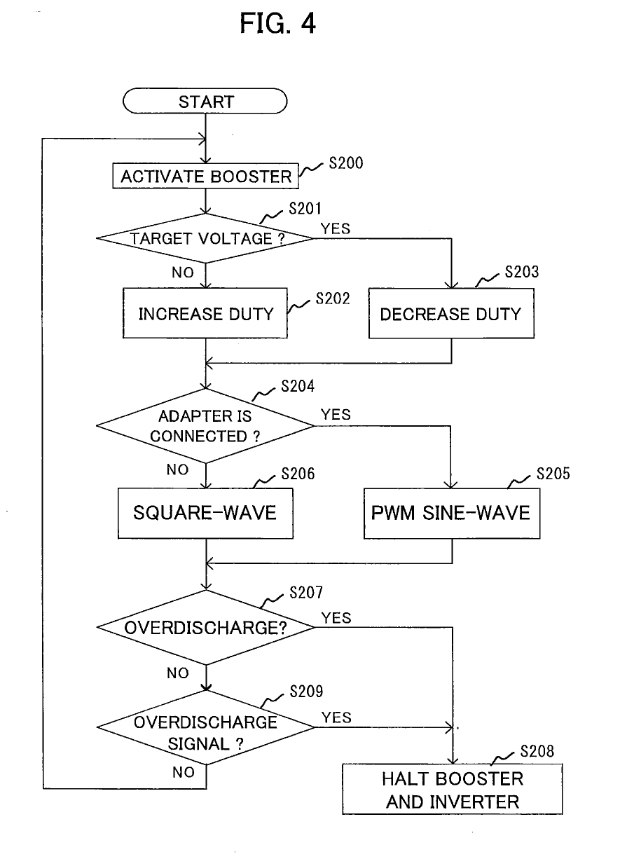

Next, a control process performed by the microcomputer 28 in the preferred embodiment for controlling the power supplied to the AC motor 42 will be described with reference to the flowchart in FIG. 4. The microcomputer 28 begins the process shown in the flowchart of FIG. 4 when the power switch 221 is turned on while the battery pack 5 is mounted on the inverter 2 or when the battery pack 5 is mounted on the inverter 2 while the power switch 221 is on. The microcomputer 28 is started when the constant-voltage circuit 222 begins supplying the power supply voltage Vcc.

In S200 at the beginning of the control process, the microcomputer 28 activates the booster circuit unit 23 by outputting the first PWM signal to the FET 232. In S201 the microcomputer 28 determines whether or not the boost AC voltage (detection voltage) at the capacitor 242 is greater than a target voltage (140 V, for example) based on the boost voltage detected by the boost voltage detection unit 25. If the detection voltage is greater than the target voltage (S201: YES), in S203 the microcomputer 28 outputs the first PWM signal having a reduced duty cycle to the gate of the FET 232. If the detection voltage is less than or equal to the target voltage (S201: NO), in S202 the microcomputer 28 outputs the first PWM signal with an increased duty cycle to the gate of the FET 232.

In S204 the microcomputer 28 determines whether or not the adapter 3 is connected to the inverter 2 based on the output signal from the adapter identification unit 6, i.e., based on the voltage inputted into the microcomputer 28 from the adapter identification unit 6. When the adapter 3 is connected to the inverter 2, a divided voltage of the power supply voltage Vcc by the first resistor 61 and the second resistor 62 is inputted into the microcomputer 28. On the other hand, if the adapter 3 is not connected to the inverter 2, the power supply voltage Vcc is inputted directly through the first resistor 61 into the microcomputer 28. Consequently, the voltage inputted from the adapter identification unit 6 into the microcomputer 28 is smaller when the adapter 3 is connected than when the adapter 3 is not connected. Thus, the microcomputer 28 can determine whether or not the adapter 3 is connected to the inverter 2 based on whether or not the inputted voltage is greater than a prescribed voltage, such as 3 V.

If the adapter 3 is connected (S204: YES), in S205 the microcomputer 28 outputs second PWM signals to the FETs 261-264 of the inverter circuit 26 in order to output a PWM sine-wave AC power from the inverter circuit 26. When the adapter 3 is not connected (S204: NO), in S206 the microcomputer 28 outputs second PWM signals to the FETs 261-264 of the inverter circuit 26 in order to output a square-wave AC power from the inverter circuit 26.

In S207 the microcomputer 28 determines whether or not the battery voltage detected by the battery voltage detection unit 21 is smaller than a prescribed over-discharge voltage. If the detected battery voltage is smaller than the prescribed over-discharge voltage (S207: YES), then the microcomputer 28 determines that the battery pack 5 is in an over-discharge state. Accordingly, in S208 the microcomputer 28 halts the first and second PWM signals to stop the operations of the booster circuit unit 23 and inverter circuit 26, thereby halting the supply of power from the battery pack 5.

However, if the battery voltage is greater than or equal to the over-discharge voltage (S207: NO), in S209 the microcomputer 28 determines that an over-discharge signal was inputted from the battery pack 5 via the LD terminal. When an over-discharge signal has been inputted (S209: YES), then in S208 the microcomputer 28 halts the operations of the booster circuit unit 23 and inverter circuit 26 according to the same process described when the battery voltage is smaller than the prescribed over-discharge voltage (S207: YES). However, if an over-discharge signal was not inputted (S209: NO), the microcomputer 28 returns to S200.

With the structure according to the preferred embodiment, the power supply device 1 can output a sine-wave AC power through the adapter 3 detachably mounted on the inverter 2. Accordingly, the power supply device 1 can stably drive a power tool, even when the power tool is equipped with a phase-control function for controlling motor speed. Further, since power tools that possess no phase-control function do not require the adapter 3, portability of the power supply device 1 is not degraded because the operator need only carry the inverter 2.

While the invention has been described in detail with reference to specific embodiments thereof, it would be apparent to those skilled in the art that many modifications and variations may be made therein without departing from the spirit of the invention, the scope of which is defined by the attached claims.

For example, while the adapter identification unit 6 was configured of the first resistor 61 and the second resistor 62 in the preferred embodiment, a mechanical switch may be employed instead. The switch is closed when the adapter 3 is connected so that the adapter identification unit 6 inputs the power supply voltage Vcc into the microcomputer 28, and is open when the adapter 3 is not connected so that the adapter identification unit 6 does not input the power supply voltage Vcc into the microcomputer 28. In this way, the microcomputer 28 can detect whether the adapter 3 is connected. Alternatively, the operator of the power supply device 1 may be required to manually switch the switch in the adapter identification unit 6. Hence, the adapter identification unit 6 may have any configuration that enables the microcomputer 28 to detect the connected state of the adapter 3.

In the preferred embodiment, the battery pack 5 that is connected to the inverter 2 is described as a 14.4-V lithium battery pack, but the inverter 2 may be configured to be connectable to different types of battery packs in addition to those housing lithium batteries, such as battery packs configured of nickel cadmium batteries or nickel metal hydride batteries, or may be configured to be connectable to a plurality of battery packs with various battery voltages. In such cases, the inverter 2 must be provided with identifying means (resistors, for example) for identifying the type and voltage of batteries in the connected battery pack. The microcomputer 28 then identifies the connected battery pack based on information received from the resistors and controls step-up operations for the booster circuit unit 23 according to the type of battery pack. This configuration improves the operability of the power supply device 1 since the power supply device 1 can use a variety of battery packs.

In the flowchart of FIG. 4, the microcomputer 28 determines whether or not the battery pack 5 is in an over-discharge state in S207-S209, but the microcomputer 28 may be configured to make this determination at any point in time.

In the flowchart of FIG. 4, an overcurrent detection may be further performed. Specifically, the microcomputer 28 halts the operations of the booster circuit unit 23 and inverter circuit 26 when the current detected by the current detection resistor 27 has exceeded a predetermined current. With this construction, it can be prevented that the battery pack 5, the AC motor 42, and FETs 231 and 261-264 are damaged due to the heat generated by the overcurrent.

The preferred embodiment described above makes the assumption that an adapter 3 is not connected to the inverter 2 for power tools that are driven by square-wave power, such as a lawn mower, but it is also possible that a power tool that can be driven by square-wave power can also be driven by power having the sine wave shown in FIG. 3(c) inputted via the adapter 3. Therefore, if portability of the power supply device 1 is not an issue, a power supply device 1 having the adapter 3 connected to the inverter 2 may be used for a wide variety of power tools.

1. A power supply device comprising:
an inverter that converts a DC power supplied from a battery pack into an AC power and outputs the AC power; and
an adapter that shapes a waveform of the AC power outputted from the inverter.

2. The power supply device according to claim 1, further comprising a controller that controls the inverter to change a waveform of the AC power to be outputted in accordance with a connection status of an adapter to the inverter.

3. The power supply device according to claim 2, wherein the controller controls the inverter to output a square-wave AC power having a commercial frequency when the adapter is not connected to the inverter, and
wherein the controller controls the inverter to output a PWM sine-wave AC power when the adapter is connected to the inverter.

4. The power supply device according to claim 3, wherein the inverter comprises:
a first switching element that is turned on/off to convert the DC power supplied from the battery pack into an AC power;
a rectifying/smoothing circuit that converts the AC power converted by the first switching element into a DC power; and
an inverter circuit including a plurality of second switching elements that is turned on/off to convert the DC power converted by the rectifying/smoothing circuit into an AC power, wherein the controller controls the ON/OFF of the plurality of second switching elements based on the connection status.

5. The power supply device according to claim 3, wherein the adapter includes a low-pass filter that shapes the PWM sine-wave AC power into a sine-wave AC power.

6. The power supply device according to claim 2, wherein the adapter includes an identifying member that outputs an identifying signal to the controller when the adapter is connected to the inverter.

7. The power supply device according to claim 6, wherein the inverter further includes a first resistor having a first terminal connected to a power source and a second terminal connected to the controller, and
wherein the identifying member includes a first resistor connected between the second terminal and a ground when the adapter is connected to the inverter.

8. A power tool connectable to the power supply according to claim 1, comprising:
an AC motor; and
a trigger switch disposed between the adapter and the AC motor when the adapter is connected between the inverter and the AC motor and between the inverter and the AC motor when the adapter is not connected between the inverter and the AC motor.

9. A power supply system comprising:
the power supply device according to claim 1; and
the power tool according to claim 7.

10. An adapter comprising:
a first terminal connectable to an inverter that converts a DC power supplied from a battery pack into an AC power and outputs the AC power;
a shaping unit that shapes a waveform of the AC power outputted from the inverter; and
a second terminal that outputs the shaped waveform.
